(19) United States
(12) Patent Application Publication
(10) Pub. No.: US 2017/0314720 A1
(43) Pub. Date: Nov. 2, 2017

(54) Apparatus and Methods for Coupling a Valve to a Duct

(71) Applicant: COPRECITEC, S.L., Aretxabaleta (ES)

(72) Inventor: Mikel ITURBE ARRIOLA, Arrasate (ES)

(21) Appl. No.: 15/496,613

(22) Filed: Apr. 25, 2017

(30) Foreign Application Priority Data
May 2, 2016 (ES) U201630541

(51) Int. Cl. F16L 55/07

(52) U.S. Cl. CPC F16L 55/07

(57) ABSTRACT

A gas distribution assembly that includes a valve mounted on a distribution duct. According to one implementation the body of the valve is supported on the duct by support having a base and a plurality of arms extending from the base. The arms have surfaces that rests on projections of the valve body. A fixation device is furthered used to secure the support to the valve body. The support is configured to hold the valve body on the duct in the event the fixation device fails to secure the support to the valve body.

### CROSS-REFERENCE TO RELATED APPLICATION

This applications relates to and claims the benefit and priority to Spanish Patent Application No. P201630541, filed May 2, 2016.

### TECHNICAL FIELD

The present invention relates to gas distribution assemblies comprising gas regulating valves mounted on a gas distribution duct, and gas cooking appliances incorporating the gas distribution assemblies.

### BACKGROUND

Gas distribution assemblies for gas cooking appliances are known, and they are equipped with rotary-type manually operated gas valves and a duct distributing the gas. The valves are mounted in the duct in fluid communication with the duct, and they are fixed to the duct being attached to a support.

Safety issues due to gas leaks occurring because the attachment between the valves and support has sustained some sort of mishap, such as breaking, for example, are known.

ES1077154U describes a gas distribution assembly suitable for being mounted in a gas cooking appliance, comprising a gas distribution duct suitable for being connected to a gas connection, at least one gas regulating valve mounted on the gas distribution duct, a support which is associated with the gas regulating valve and supported on the gas distribution duct, and attachment means for attaching each gas regulating valve with the support.

### SUMMARY OF THE DISCLOSURE

According to some implementations a gas distribution assembly is provided that comprises a gas distribution duct suitable for being connected to a gas connection, at least one gas regulating valve mounted on the gas distribution duct, a support which is associated with the gas regulating valve and supported on the gas distribution duct, and attachment means for attaching at least one attachment area of each gas regulating valve with at least one attachment area of the respective support. Each attachment area comprises a respective hole, the attachment means at least partially going through the holes for attaching both areas.

The support comprises engagement means for fixing the support with the gas regulating valve from both sides of the gas distribution duct.

If for any reason the attachment means breaks in any area of the length thereof comprised between the gas regulating valve and the support, the valve and the support will continue to be attached and maintain the tightening torque, since the engagement means for engaging the support continue to secure the support to the gas regulating valve, the support acting like a safety element. Safety issues due to gas leaks occurring because one of the attachment means has broken are thereby prevented. It is a simple, easy-to-implement and low-cost solution.

These and other advantages and features will become evident in view of the drawings and detailed description.

### BRIEF DESCRIPTION OF THE DRAWINGS

FIG. 1 shows a perspective view of a gas distribution assembly according to one implementation.

FIG. 2 shows a second perspective view of the gas distribution assembly of FIG. 1.

FIG. 3 shows a perspective view of the gas regulating valve of the gas distribution assembly of FIG. 1.

FIG. 4 shows a perspective view of the gas distribution duct of the gas distribution assembly of FIG. 1.

FIG. 5 shows a perspective view of the support of the gas distribution assembly of FIG. 1.

FIG. 6 shows a second perspective view of the support of the gas distribution assembly of FIG. 1.

FIG. 7 shows a detailed front view of the gas distribution assembly of FIG. 1.

FIG. 8 shows a section view of the gas distribution assembly of FIG. 1.

### DETAILED DESCRIPTION

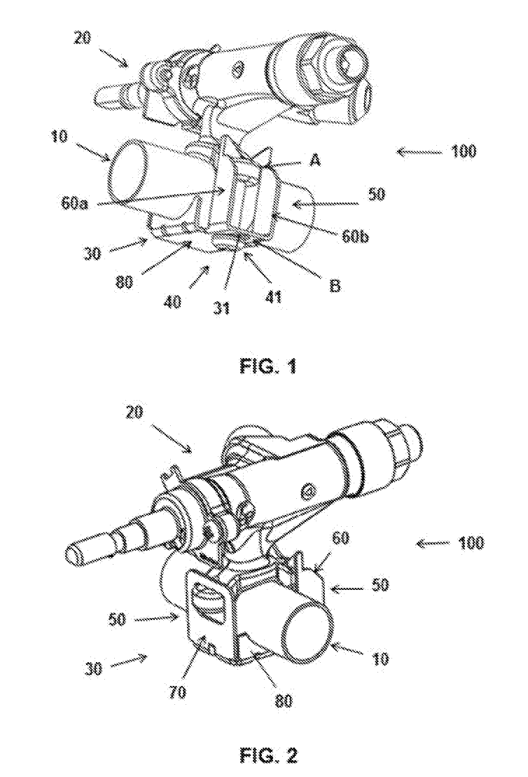

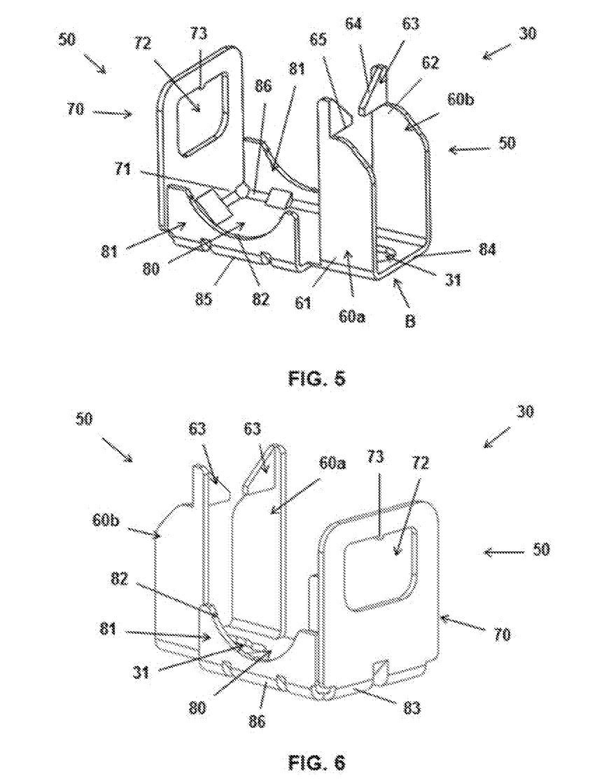

FIG. 1 shows a perspective view of an embodiment of the gas distribution assembly 100 of the invention, and FIG. 2 shows a second perspective view of the gas distribution assembly 100 of FIG. 1. FIG. 5 shows a perspective view of the support 30 of the gas distribution assembly 100 of FIG. 1, and FIG. 6 shows a second perspective view of the support 30 of the gas distribution assembly 100 of FIG. 1.

According to some implementations the gas distribution assembly 100 comprises a gas distribution duct 10, which is typically an elongated tube having a circular section, suitable for being connected to a gas connection, not shown in the drawings. In other embodiments of the gas distribution assembly, not shown in the drawings, the gas distribution assembly can have other configurations, with square sections or other shapes.

As many gas regulating valves as required are mounted in a linear manner on the gas distribution duct 10 in the gas cooking appliance, only one gas regulating valve 20 being shown in the drawings. In other implementations of the gas distribution assembly, not shown in the drawings, instead of gas regulating valves they can be gas regulating cocks. Each valve has an associated support 30 which is supported on the gas distribution duct 10. The gas distribution assembly 100 also comprises attachment means 40 which allow attaching an attachment area A of the gas regulating valve 20 with an attachment area B of the respective support 30, the gas distribution duct 10 being arranged between the gas regulating valve 20 and the support 30. In other implementations of the gas distribution assembly, not shown in the drawings, the gas regulating valves 20 can be associated with a single support.

In the implementation shown in the figures, the attachment means 40 comprises a screw 41. The screw 41 comprises a head 43 and a shank 44 comprising a threaded section 45 at one end 42 of the screw 41, opposite the head 43. In other embodiments of the screw 41, the threaded section can span other lengths, even reaching the base of the head 43. In the embodiment of the gas distribution assembly 100 that is shown, the attachment area B of the support 30 comprises a through hole 31 with a diameter greater than the outer diameter of the shank of the screw 41, and the attachment area A of the gas regulating valve 20 comprises a threaded hole 23. The shank 44 of the screw 41 goes through the through hole 31 which is arranged in the support 30, and the threaded section 45 of the end 42 of the screw 41 is screwed into the threaded hole 23 arranged in the gas regulating valve 20.

In other implementations of the gas distribution assembly 100 (not shown in the drawings), the attachment means comprises, for example, a rivet or an elastic pin. One of the attachment areas A, B comprises at least a first through hole that the rivet or the pin goes through, and the other attachment area A, B also comprises a second through hole, an end of the rivet or pin being anchored to the second through hole. According to one implementation the attachment area B of the support comprises the first through hole, and the attachment area A of the gas regulating valve comprises the second through hole.

In the implementation of the gas distribution assembly 100 that is shown in the figures, the support 30 is a U-shaped metal part comprising a base 80, and engagement means 50 engaging the gas regulating valve 20 from both sides of the gas distribution duct 10. These engagement means 50 comprise side arms 60a, 60b, 70 which are attached with the base 80 and engage the gas regulating valve 20, the side arms 60a, 60b, 70 forming the arms of the U shape. Therefore, when the gas distribution duct 10 is supported at the base 80 of the support 30, the side arms 60a, 60b, 70 vertically project from both sides of the gas distribution duct 10 to engage the gas regulating valve 20.

The base 80 may be quadrangular in the form of a rectangle, with two opposite sides 83, 84, and two other sides 85, 86 opposite sides 83, 84. The side arms 60a, 60b, 70 are attached to the opposite sides 83, 84 of the base 80, the side arms 60a, 60b being two elastic arms attached to the base 80 on the side 84, and the side arm 70 is a rigid arm attached to the base 80 on the opposite side 83. The elastic arms 60a and 60b are arranged facing one another and are each attached at one end 61 to the base 80 on side 84, from each of the sides 85, 86, respectively, this attachment being a pivoting elastic attachment. This is achieved with the material used for making the support 30, for example a spring steel, and with the design of the part, the length of the elastic arms being large compared with the thickness of the attachment of the end 61 with the base 80, and without any added element strengthening the attachment.

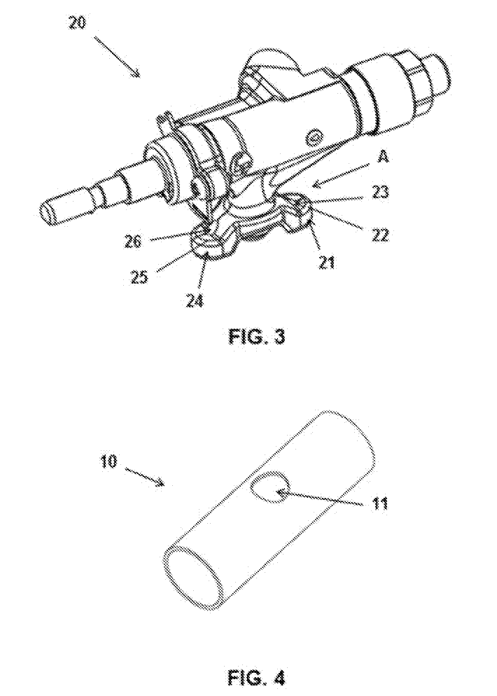

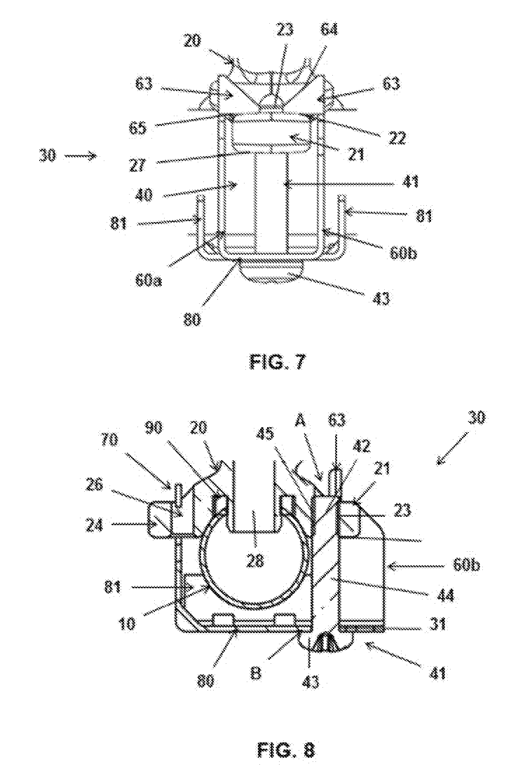

FIG. 3 shows a perspective view of the gas regulating valve 20 of the gas distribution assembly 100 of FIG. 1, and FIG. 4 shows a perspective view of the gas distribution duct 10 of the gas distribution assembly 100 of FIG. 1. FIG. 7 shows a detailed front view of the gas distribution assembly 100 of FIG. 1, and FIG. 8 shows a section view of the gas distribution assembly 100 of FIG. 1.

The gas regulating valve 20 comprises an arcuate mounting seat for being superimposed on the gas distribution duct 10, the mounting seat comprising two projections 21, 24, one on both sides of the gas regulating valve 20. The projections 21, 24 laterally project from the body of the gas distribution duct 10, when the gas regulating valve 20 is mounted on the gas distribution duct 10. In this implementation of the gas distribution assembly 100, the projection 21 of the mounting seat comprises the attachment area A of the gas regulating valve 20, the projection 21 comprising an upper surface 22 and a lower surface 27, and the threaded hole 23 going through it.

In this implementation, the gas distribution duct 10 is a cylindrical tube comprising one hole 11 for each gas regulating valve 20. Furthermore, each gas regulating valve 20 also comprises an inlet hole 28 in fluid communication with the corresponding hole 11 of the gas distribution duct 10, when the gas regulating valve 20 is mounted on the gas distribution duct 10. The gas distribution assembly 100 also comprises a washer 90 made of elastomer for each attachment of gas regulating valve 20 and gas distribution duct 10, and in other implementations not shown in the drawings, also comprises a smooth sleeve, usually of metal. Before mounting the gas regulating valve 20 and the gas distribution duct 10, the washer 90 is mounted around the inlet hole 28 of the gas regulating valve 20, in a housing of the gas regulating valve 20 arranged to that end. Therefore, when the gas regulating valve 20 is mounted on the gas distribution duct 10, the washer 90 allows preventing gas leaks through the attachment area.

The base 80 of the support 30 further comprises two seats 81, which are projections that project vertically from the sides 85, 86 of the base 80, respectively. In this implementation and according to the cylindrical shape of the gas distribution duct 10, the seats 81 have a circular shape at their upper edge that allows supporting the gas distribution duct 10. The seats 81 comprise along their edge three distributed protuberances 82 used for blocking the movement of the gas distribution duct 10, and keeping it in its place. Naturally the number of protuberances 82 may vary.

Another end 62 of the elastic arms 60a and 60b, opposite end 61, elastically engages the gas regulating valve 20. In this implementation of the gas distribution assembly 100, each elastic arm 60a and 60b comprises at its end 62 a flange 63 that projects towards the projection 21 of the gas regulating valve 20. This flange 63 has a triangular shape, with one side attached to the end 62 of the elastic arms 60a and 60b, one free inclined side 64 inclining with a decreasing angle towards the projection 21, forming a downward ramp, and one horizontal side 65 that is free.

The side arm 70 is a rigid arm attached to the base 80 on the side 83 opposite side 84 where the elastic arms 60a, 60b are arranged. The side arm 70 is a rigid arm that is attached at one end 71 to the base 80 on the side 83, this attachment being rigid. This is achieved by means of the design of the part and strengthening the attachment with structural elements. The rigid arm 70 comprises a second end, opposite end 71, and close to the second end, the rigid arm 70 comprises a hole 72 going through the wall of the rigid arm 70 with a quadrangular shape. The hole 72 of the rigid arm 70 comprises at its edge a protuberance 73 arranged in the central upper part of the edge. Naturally the number of protuberances 73 may vary.

The attachment area B of the support 30 is arranged at the base 80 on the side 84 in which the two elastic arms 60a, 60b are arranged, this attachment area B comprising the through hole 31. In other implementations of the gas distribution assembly 100 not shown in the drawings, the attachment area A of the gas regulating valve 20 is arranged in the projection 24 comprising the threaded hole 23, and the attachment area B of the support 30 is arranged on the same side 84 of the base 80, the elastic arms 60a, 60b of the support 30 being arranged on the same side of the gas regulating valve 20 as the attachment area A. Naturally the threaded hole 23 can be arranged on the side 84 of the base 80 of the support 30, and the through hole 31 can be arranged in the projection 21 or 24 of the gas regulating valve 20, but always on the same side of the gas regulating valve 20 as the position of the attachment area B of the support 30.

To form the attachment between the gas regulating valve 20 and the support 30 and to generate a tightening torque that assures leak-tightness, first the rigid arm 70 of the support 10 engages the gas regulating valve 20, introducing the hole 72 of the rigid arm 70 around the projection 24 of the gas regulating valve 20. This projection 24 comprises a through hole 26, and the protuberance 73 of the hole 72 is introduced in the hole 26. In other implementations of the gas distribution assembly 100, the hole 26 can be other than a through hole.

The gas distribution duct 10 is supported on the seats 81 of the support 30, putting the inlet hole 28 of the gas regulating valve 20 in fluid communication with the corresponding hole 11 of the gas distribution duct 10, tightening the washer 90 against the hole 11. The two elastic arms 60a, 60b of the support 30 are arranged on the other side of the gas distribution duct 10, with respect to the side on which the rigid arm 70 is located, the inclined surface 64 of the flanges 63 that are in contact with the lower surface 27 of the projection 21 of the gas regulating valve 20 being pushed vertically upwards. Due to the pushing force and the pivoting elasticity of the elastic arms 60a, 60b, the elastic arms 60a, 60b open up, the inclined surface 64 sliding over the lower surface 27, and finally the horizontal surfaces 65 of the flanges 63 are superimposed on the upper surface 22 of the projection 21. The elastic arms 60a, 60b are thereby engaged in the projection 21 of the gas regulating valve 20. Likewise, in the implementation of the gas distribution assembly 100 in which the attachment area A is arranged in the projection 24, the elastic arms 60a, 60b are engaged in the upper surface 25 of the projection 24 of the gas regulating valve 20. Then the screw 41 is introduced in the attachment area B in the through hole 31 of the support 30, and the end 42 of the screw 41 is screwed into the attachment area A in the threaded hole 23 of the gas regulating valve 20, the head 43 of the screw 41 being supported on the outer part of the base 80 of the support 30.

If for any reason the screw were to fail, for example breaking due to a poor surface treatment, the tightness between the gas regulating valve 20 and the gas distribution duct 10, and therefore the leak-tightness between the inlet hole 28 of the gas regulating valve 20 and the corresponding hole 11 of the gas distribution duct 10, would be maintained since the support 30 continues to engage the gas regulating valve 20 through the fixing means 50.

In other implementations of the gas distribution assembly not shown in the drawings, each of the two projections 21, 24 of the gas regulating valve 20 comprises an attachment area A comprising the threaded hole 23. In that case, the support 30 comprises an attachment area B on each side, with a through hole 31. The attachment means 40 for the attachment of the gas regulating valve 20 and the support 30 comprise two screws 41, each screw 41 being inserted into the respective through hole 31, and each screw 41 being screwed into the respective threaded hole 23.

What is claimed is:

1. A fluid distribution assembly comprising:
a duct having a sidewall and an opening extending through the sidewall;
a valve positioned on the duct, the valve having a valve body with an inlet in fluid communication with the duct via the opening in the sidewall of the duct, the valve body including a first projection on a first side of the valve body and a second projection on a second side of the valve body opposite the first side, the first projection having a hole;
a support configured to secure the valve to the duct, the support having a base that is supported on the duct, the base having a through hole that is axially aligned with and spaced apart from the hole in the first projection, the base having a first side that faces toward the valve body and a second side that faces away from the valve body, the base having first and second sides respectively located on the first and second sides of the valve body;
each of the first and second projections of the valve body having a first side that faces towards the base of the support and a second side that faces away from the base of the support;
the support further comprising a first arm extending from the first side of the base and a second arm extending from the second side of the base, the first arm having a surface spaced a distance from the base that rests on the second side of the first projection of the valve body, the second arm of the support being supported on the second projection of the valve body;
a fixation device that secures the support to the valve body, the fixation device having a head and a shank extending from the head, the head resting on the second side of the base on an area that surrounds the through hole, the shank extending through the through hole of the base and into the hole in the first projection;
wherein the base and first and second arms of the support are arranged to hold the valve body on the duct in the event the fixation device fails to secure the support to the valve body.

2. The fluid distribution assembly according to claim 1, wherein the first arm is attached to the base in an elastically pivoting manner.

3. The fluid distribution assembly according to claim 1, wherein the second arm is more rigid than the first arm.

4. The fluid distribution assembly according to claim 1, wherein the second arm includes a through hole comprising an edge that is supported on the second projection.

5. The fluid distribution assembly according to claim 4, wherein the second projection of the valve body includes a hole and the edge of the through hole of the second arm includes a projection that resides in the hole in the second projection.

6. The fluid distribution assembly according to claim 1, wherein the surface of the first arm that rests on the second side of the first projection is a part of a flange located at or near an end of the first arm opposite the base.

7. The fluid distribution assembly according to claim 6, wherein the flange includes an inclined surface inclining with a decreasing angle towards the first projection with the surface that rests on the second side of the first projection being a substantially horizontal surface.

8. The fluid distribution assembly according to claim 1, wherein the first hole in the first projection of the valve body comprises internal threads and the fixation device comprises a screw having external threads disposed along at least a portion of the shank, the external threads being engaged with the internal threads to secure the support to the valve body.

9. The fluid distribution assembly according to claim 1, wherein the fixation device is a rivet.

10. The fluid distribution assembly according to claim 1, further comprising a third arm extending from the first side of the base, the third arm being spaced apart from the first arm, the third arm having a surface spaced a distance from the base that rests on the second side of the first projection of the valve body.

11. A fluid distribution assembly according to claim 10, wherein the first and third arms are located on opposite sides of the through hole in the base of the support.

12. A fluid distribution assembly according to claim 11, wherein at least one of the first and third arm is attached to the base in an elastically pivoting manner.

13. A fluid distribution assembly according to claim 11, wherein both of the first and third arm is attached to the base in an elastically pivoting manner.

14. The fluid distribution assembly according to claim 10, wherein the second arm is more rigid than one or both of the first and third arms.

15. The fluid distribution assembly according to claim 10, wherein the second arm includes a through hole comprising an edge that is supported on the second projection.

16. The fluid distribution assembly according to claim 15, wherein the second projection of the valve body includes a hole and the edge of the through hole of the second arm includes a projection that resides in the hole in the second projection.

17. The fluid distribution assembly according to claim 10, wherein at least one of the surfaces of the first and second arms that rest on the second side of the first projection is a part of a flange.

18. The fluid distribution assembly according to claim 17, wherein the flange includes an inclined surface inclining with a decreasing angle towards the first projection with the surface that rests on the second side of the first projection being a substantially horizontal surface.

19. The fluid distribution assembly according to claim 10, wherein the first hole in the first projection of the valve body comprises internal threads and the fixation device comprises a screw having external threads disposed along at least a portion of the shank, the external threads being engaged with the internal threads to secure the support to the valve body.

20. The fluid distribution assembly according to claim 10, wherein the fixation device is a rivet.
